(19) United States
(12) Patent Application Publication
(10) Pub. No.: US 2026/0216935 A1
(43) Pub. Date: Jul. 30, 2026

(54) INJECTION MOLDING APPARATUS

(71) Applicant: SEIKO EPSON CORPORATION, Tokyo (JP)

(72) Inventors: Takuro FUSHIMI, MATSUMOTO-SHI (JP); Kohei YAMADA, SHIOJIRI-SHI (JP)

(73) Assignee: SEIKO EPSON CORPORATION, Tokyo (JP)

(21) Appl. No.: 19/403,008

(22) Filed: Nov. 27, 2025

(30) Foreign Application Priority Data
Nov. 28, 2024 (JP) 2024-207308

(51) Int. Cl. B29C 45/76; B29C 45/64

(52) U.S. Cl. CPC B29C 45/7613; B29C 45/64; B29C 45/7653; B29C 45/768; B29C 2045/7606; B29C 2945/76153; B29C 2945/76287; B29C 2945/76351; B29C 2945/76461; B29C 2945/76505; B29C 2945/76658; B29C 2945/76933

(57) ABSTRACT

An injection molding apparatus includes: an injection unit that injects a material of a molded article into a mold; a mold clamping unit to which the mold is attached and which clamps the mold; an optical measurement unit that optically measures the material; and a control unit that controls the injection unit, the mold clamping unit, and the optical measurement unit. The injection unit includes a material supply unit that supplies the material, a flow path through which the supplied material flows, and a nozzle that injects the material into the flow path. The optical measurement unit includes a light guide unit that guides light into the flow path, an irradiation unit that irradiates the material with light, and a Raman spectrometer that receives scattered light from the material. The control unit determines a state of the material based on a Raman spectrum obtained from the Raman spectrometer.

The present application is based on, and claims priority from JP Application Serial Number 2024-207308, filed November 28, 2024, the disclosure of which is hereby incorporated by reference herein in its entirety.

### BACKGROUND

### 1. Technical Field

The present disclosure relates to an injection molding apparatus.

### 2. Related Art

There is known an injection molding apparatus that injects a plasticized material toward a mold cavity and molds a molded article by curing the material.

For example, JP-A-2024 -65431 describes an injection molding machine including an injection device that melts and injects a resin material, a mold device that molds a molten resin injected from the injection device, an analysis device that analyzes a gas generated during injection molding, and a control device that reflects an analysis result obtained in the analysis device in a driving operation of the injection device. The injection device includes a heating cylinder, a heater fitted around the heating cylinder, a plasticizing screw rotatably inserted into the heating cylinder, and a raw material hopper for storing resin pellets supplied as a raw material into the heating cylinder. The gas generated from the molten resin is supplied to the analysis device through a gas pipe coupled to a heating cylinder vent of the heating cylinder.

JP-A-2024-65431 is an example of the related art.

In the injection molding machine described in JP-A-2024-65431, the heating cylinder vent is either formed of fine holes or a porous material is interposed. Therefore, the material may flow into the hole of the heating cylinder vent and leak to the outside, which may cause problems in the molded article, such as instability in the weight of the molded article.

### SUMMARY

One aspect of an injection molding apparatus according to the present disclosure is an injection molding apparatus for performing injection molding of a molded article using a mold, the injection molding apparatus including: an injection unit configured to inject a material of the molded article into the mold; a mold clamping unit to which the mold is attached and which clamps the mold; an optical measurement unit configured to optically measure the material; and a control unit configured to control the injection unit, the mold clamping unit, and the optical measurement unit. The injection unit includes a material supply unit configured to supply the material, a flow path through which the supplied material flows, and a nozzle configured to inject the material into the flow path. The optical measurement unit includes a light guide unit configured to guide light into the flow path, an irradiation unit configured to irradiate the material with light via the light guide unit, and a Raman spectrometer configured to receive scattered light from the material via the light guide unit. The control unit is configured to determine a state of the material based on a Raman spectrum obtained from the Raman spectrometer.

One aspect of an injection molding apparatus according to the present disclosure is an injection molding apparatus for performing injection molding of the molded article using a mold having a cavity, the injection molding apparatus including: an injection unit configured to inject a material of the molded article into the cavity; a mold clamping unit to which the mold is attached and which clamps the mold; an optical measurement unit configured to optically measure the material; and a control unit configured to control the injection unit, the mold clamping unit, and the optical measurement unit. The optical measurement unit includes a light guide unit configured to guide light into the cavity, an irradiation unit configured to irradiate the material with light via the light guide unit, and a Raman spectrometer configured to receive scattered light from the material via the light guide unit. The control unit is configured to determine a state of the material based on a Raman spectrum obtained from the Raman spectrometer.

### BRIEF DESCRIPTION OF THE DRAWINGS

FIG. 1 is a diagram schematically illustrating an injection molding apparatus according to a first embodiment.

FIG. 2 is a diagram schematically illustrating an optical measurement unit of the injection molding apparatus according to the first embodiment.

FIG. 3 is a flowchart illustrating an operation of the injection molding apparatus according to the first embodiment.

FIG. 4 is a graph showing Raman spectra of the material after being retained for 3 hours and the refreshed material.

FIG. 5 is a diagram schematically illustrating an optical measurement unit of an injection molding apparatus according to a first modification of the first embodiment.

FIG. 6 is a diagram schematically illustrating an optical measurement unit of an injection molding apparatus according to a second modification of the first embodiment.

FIG. 7 is a diagram schematically illustrating an optical measurement unit of an injection molding apparatus according to a second embodiment.

FIG. 8 is a diagram schematically illustrating an extrusion unit and a light guide unit of the injection molding apparatus according to the second embodiment.

### DESCRIPTION OF EMBODIMENTS

Preferred embodiments of the present disclosure will hereinafter be described in detail with reference to the drawings. Note that the embodiments to be described below do not unreasonably limit the present disclosure set forth in the appended claims. In addition, not all configurations to be described below are necessarily essential component elements of the present disclosure.

### 1. First Embodiment

### 1.1. Injection Molding Apparatus

### 1.1.1. Configuration

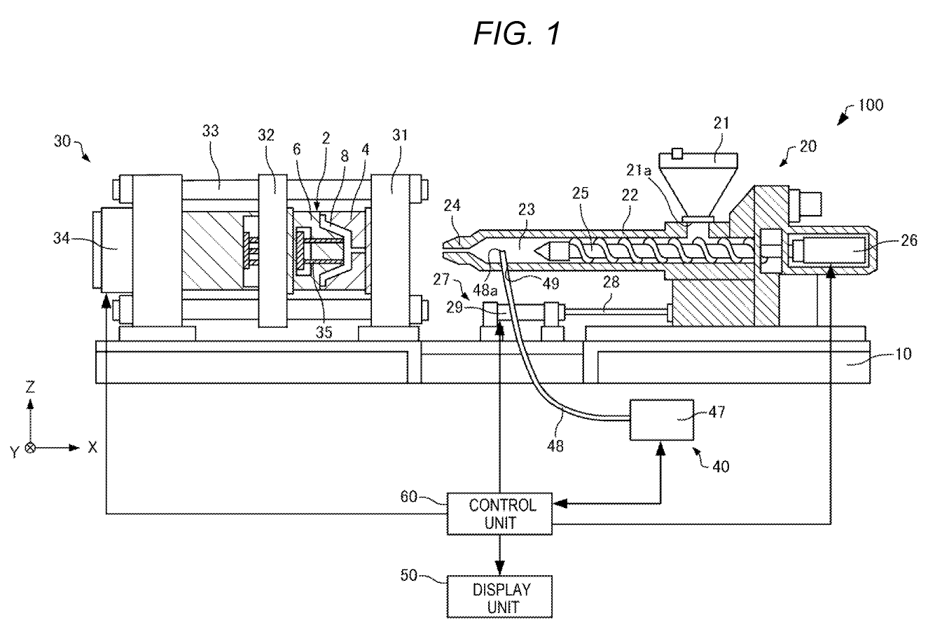

First, an injection molding apparatus according to a first embodiment will be described with reference to the drawings. FIG. 1 is a cross-sectional view schematically illustrating an injection molding apparatus 100 according to the first embodiment. FIG. 1 illustrates an X-axis, a Y-axis, and a Z-axis as three axes orthogonal to each other. An X-axis direction and a Y-axis direction are, for example, the horizontal directions. A Z-axis direction is, for example, the vertical direction.

The injection molding apparatus 100 performs injection molding of a molded article using a mold 2. As illustrated in FIG. 1, the injection molding apparatus 100 includes, for example, a base 10, an injection unit 20, a mold clamping unit 30, an optical measurement unit 40, a display unit 50, and a control unit 60.

The base 10 supports the injection unit 20 and the mold clamping unit 30. The shape of the base 10 is not particularly limited.

The injection unit 20 injects a material serving as a raw material of the molded article into the mold 2. Specifically, the injection unit 20 injects the material into the cavity 8 of the mold 2. The injection unit 20 includes, for example, a material supply unit 21, a heating cylinder 22, a screw 25, a drive unit 26, and an advancing/retreating actuator 27.

The material supply unit 21 stores the material. The material supply unit 21 supplies the stored material from a material discharge port 21a to the heating cylinder 22. The material supply unit 21 is, for example, a hopper. In the illustrated example, the material discharge port 21a is located at an end of the material supply unit 21 in the - Z-axis direction. The material stored in the material supply unit 21 is, for example, a polyester (PES) such as a fluorene-based polyester (OKP).

The material is supplied to the heating cylinder 22 from the material supply unit 21. In the illustrated example, the heating cylinder 22 has a tubular shape extending in the X-axis direction. The heating cylinder 22 has a flow path 23 through which the material supplied from the material supply unit 21 flows. The flow path 23 communicates with the material discharge port 21a of the material supply unit 21. The heating cylinder 22 has a nozzle 24 at a tip thereof. In the illustrated example, the nozzle 24 is provided at an end portion of the heating cylinder 22 in the - X-axis direction. In the nozzle 24, the flow path 23 is narrowed. The heating cylinder 22 injects the material from the nozzle 24. A heating unit (not illustrated) is provided on the outer wall of the heating cylinder 22. The heating unit is, for example, a heater. The heating unit heats the material in the flow path 23. The heating unit is controlled by the control unit 60.

The screw 25 is provided in the flow path 23. A spiral groove is formed on the surface of the screw 25. In the illustrated example, the screw 25 has a shape extending in the X-axis direction.

The drive unit 26 is coupled to the screw 25. In the illustrated example, the drive unit 26 is provided in the + X-axis direction of the heating cylinder 22. The drive unit 26 rotates the screw 25 about an axis parallel to the X-axis. The drive unit 26 includes, for example, a motor. The drive unit 26 is controlled by the control unit 60.

The advancing/retreating actuator 27 is provided between the base 10 and the heating cylinder 22. The advancing/retreating actuator 27 moves the screw 25 in the X-axis direction. Specifically, the advancing/retreating actuator 27 advances the screw 25 in the - X-axis direction and retracts the screw 25 in the + X-axis direction. The advancing/retreating actuator 27 includes a ball screw 28 and a drive unit 29 that operates the ball screw 28. The drive unit 29 includes, for example, a motor. The drive unit 29 is controlled by the control unit 60.

In the injection unit 20, the material in the solid state is heated while being conveyed toward the nozzle 24 by the heating unit provided on the outer wall of the heating cylinder 22 and the screw 25, and is plasticized into a flowable, paste-like material. Then, the injection unit 20 injects the plasticized material from the nozzle 24 toward the mold 2. The injection unit 20 includes an in-line type plasticizing device.

Plasticizing is a concept including melting and means changing a solid state to a flowable state. Specifically, when glass transition occurs in a material, plasticizing means setting the temperature of the material to a value equal to or higher than the glass transition point. When glass transition does not occur in a material, plasticizing means setting the temperature of the material to a value equal to or higher than the melting point.

The mold clamping unit 30 is provided in the - X-axis direction of the injection unit 20. The mold 2 is attached to the mold clamping unit 30. The mold clamping unit 30 is configured to allow the mold 2 to be attached and detached. The mold clamping unit 30 clamps the mold 2. The mold 2 has a movable mold 6 and a fixed mold 4. A cavity 8 is provided between the fixed mold 4 and the movable mold 6. A material of the mold 2 is, for example, metal, ceramic, or resin. The mold clamping unit 30 includes, for example, a fixed mold attachment portion 31, a movable mold attachment portion 32, tie bars 33, a drive unit 34, and an extrusion unit 35.

The fixed mold attachment portion 31 is provided between the movable mold attachment portion 32 and the injection unit 20. The fixed mold 4 is attached to the fixed mold attachment portion 31. The fixed mold attachment portion 31 is configured to allow the fixed mold 4 to be attached and detached.

The movable mold attachment portion 32 is provided between the fixed mold attachment portion 31 and the drive unit 34. The movable mold attachment portion 32 is movable with respect to the fixed mold attachment portion 31. In the illustrated example, the movable mold attachment portion 32 is movable in the X-axis direction along the tie bars 33. The movable mold 6 is attached to the movable mold attachment portion 32. The movable mold attachment portion 32 is configured to allow the movable mold 6 to be attached and detached. As the movable mold attachment portion 32 moves, the movable mold 6 moves.

The drive unit 34 moves the movable mold 6 in the X-axis direction. Specifically, the drive unit 34 moves the movable mold attachment portion 32 in the + X-axis direction and further moves the movable mold attachment portion 32 in the - X-axis direction. The drive unit 34 includes a motor. The drive unit 34 is controlled by the control unit 60.

When the drive unit 34 moves the movable mold attachment portion 32 in the + X-axis direction, the fixed mold 4 and the movable mold 6 are clamped, and the cavity 8 is formed. A plasticized material is injected into the cavity 8 from the injection unit 20. The material injected into the cavity 8 is cooled and solidified. Thus, a molded article corresponding to the shape of the cavity 8 is molded.

The extrusion unit 35 is provided between the fixed mold attachment portion 31 and the movable mold attachment portion 32. The extrusion unit 35 extrudes the molded article from the mold 2 by the movement of the movable mold 6. Specifically, the extrusion unit 35 extrudes the molded article from the movable mold 6 by moving the movable mold 6 in the - X-axis direction. As a result, the molded article is separated from the mold 2. The extrusion unit 35 is a rod-shaped ejector pin. In the illustrated example, the extrusion unit 35 has a shape extending in the X-axis direction. For example, a plurality of extrusion units 35 are provided.

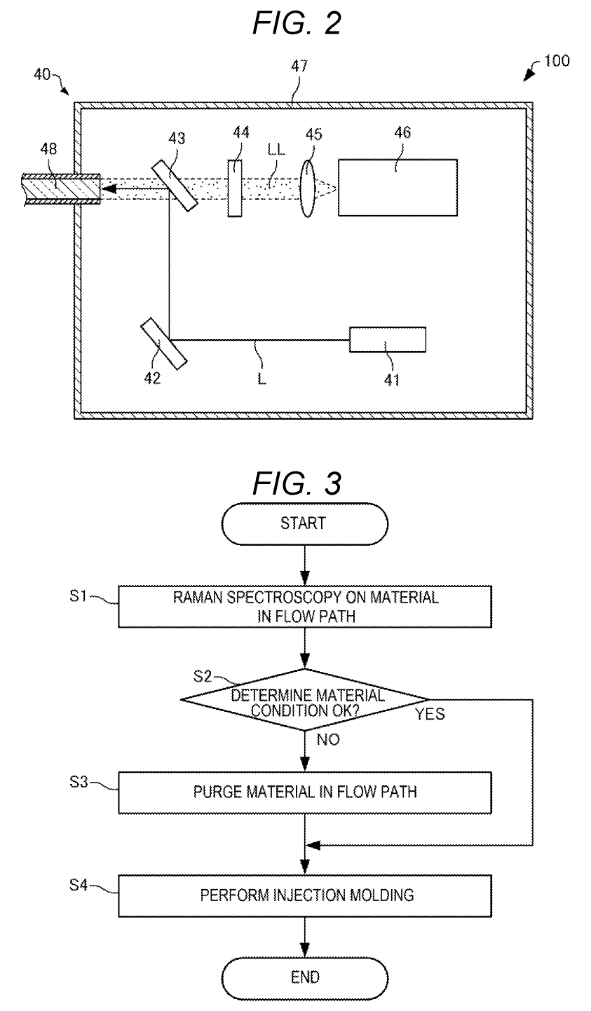

The optical measurement unit 40 optically measures a material. Specifically, the optical measurement unit 40 optically measures the material in the flow path 23. The optical measurement unit 40 may measure the material in a state before being plasticized or may measure the material after being plasticized. Here, FIG. 2 is a diagram schematically illustrating the optical measurement unit 40.

As illustrated in FIG. 2, the optical measurement unit 40 includes, for example, an irradiation unit 41, a mirror 42, a dichroic filter 43, a notch filter 44, a condenser lens 45, a Raman spectrometer 46, a housing 47, and a light guide unit 48.

The irradiation unit 41 irradiates the material in the flow path 23 with the light L via the light guide unit 48. The irradiation unit 41 is, for example, a laser light source that irradiates laser light having a wavelength of 532 nm. The light L emitted from the irradiation unit 41 is reflected by the mirror 42 and the dichroic filter 43, and then passes through the light guide unit 48, and is irradiated onto the material in the flow path 23. The irradiation of light L causes scattered light LL to be generated from the material. The scattered light LL from the material passes through the light guide unit 48, passes through the dichroic filter 43, the notch filter 44, and the condenser lens 45, and is received by the Raman spectrometer 46. In this manner, the Raman spectrometer 46 receives the scattered light LL from the material via the light guide unit 48, the dichroic filter 43, the notch filter 44, and the condenser lens 45.

The housing 47 houses the irradiation unit 41, the mirror 42, the dichroic filter 43, the notch filter 44, the condenser lens 45, and the Raman spectrometer 46. The housing 47 has a light shielding property.

The light guide unit 48 guides the light L from the irradiation unit 41 into the flow path 23. Specifically, the light guide unit 48 guides the light L from an irradiation light emission surface 48a to the material in the flow path 23. As shown in FIG. 1, the irradiation light emission surface 48a is an end on one side of the light guide unit 48. In the illustrated example, the irradiation light emission surface 48a is located in the flow path 23. Further, the light guide unit 48 guides the scattered light LL of the material generated by the light L to the Raman spectrometer 46. In the example illustrated in FIG. 2, the other end of the light guide unit 48 is located in the housing 47. The light guide unit 48 is, for example, an optical fiber. The light guide unit 48 may be a glass fiber such as a quartz fiber. The inside of the light guide unit 48 is not hollow.

As shown in FIG. 1, the light guide unit 48 is fitted into, for example, a through hole 49 formed in the heating cylinder 22. The light guide unit 48 is in contact with the inner surface of the through hole 49. The inner surface of the through hole 49 is formed by the heating cylinder 22. For example, there is no gap between the light guide unit 48 and the inner surface of the through hole 49. The through hole 49 is sealed by, for example, the light guide unit 48. The through hole 49 is formed in a side wall of the heating cylinder 22. In the illustrated example, the through hole 49 is a portion other than the nozzle 24 and is formed at a position not overlapping the screw 25. Although not illustrated, the through hole 49 may be formed in the nozzle 24.

The distance between the irradiation light emission surface 48a of the light guide unit 48 and the nozzle 24 is, for example, smaller than the distance between the irradiation light emission surface 48a and the material discharge port 21a of the material supply unit 21. In the illustrated example, the light L from the irradiation unit 41 is irradiated onto the plasticized material.

Although not illustrated, the through hole 49 may be sealed with a light-transmissive member. The light guide unit 48 may guide the light L to the material in the flow path 23 via the light-transmissive member that seals the through hole 49.

The display unit 50 displays a determination result of the state of the material when the control unit 60 determines the state of the material. The display unit 50 is implemented by, for example, a liquid crystal display (LCD), an organic electroluminescence (EL) display, an electrophoretic display (EPD), or a touch panel display.

For example, the control unit 60 is implemented by a computer including a processor, a main storage device, and an input and output interface that receives and outputs a signal from and to the outside. The control unit 60 exerts various functions by, for example, executing, by the processor, a program read into the main storage device. The control unit 60 controls the injection unit 20, the mold clamping unit 30, and the optical measurement unit 40. The control unit 60 may be implemented by a combination of a plurality of circuits instead of the computer.

### 1.1.2. Operation

FIG. 3 is a flowchart illustrating operations of the injection molding apparatus 100. Specifically, FIG. 3 is a flowchart illustrating processing of the control unit 60 of the injection molding apparatus 100.

Hereinafter, as an example, a case will be described in which, from a state in which the material used in the previous injection molding remains in the flow path 23 of the heating cylinder 22, new injection formation is started using the same type of material as the material used in the previous injection molding.

For example, a user operates an operation unit (not illustrated) to output, to the control unit 60, a processing start signal for starting processing. The operation unit is implemented by, for example, a mouse, a keyboard, and a touch panel. When the processing start signal is received, the control unit 60 starts the processing.

First, as illustrated in FIG. 3, in step S1, the control unit 60 performs Raman spectroscopy on the material used in the previous injection molding remaining in the flow path 23 of the heating cylinder 22. Specifically, the control unit 60 controls the optical measurement unit 40 to cause the irradiation unit 41 to irradiate the light L and causes the Raman spectrometer 46 to receive the scattered light LL from the material in the flow path 23.

Next, in step S2, the control unit 60 determines the state of the material based on the Raman spectrum obtained from the Raman spectrometer 46.

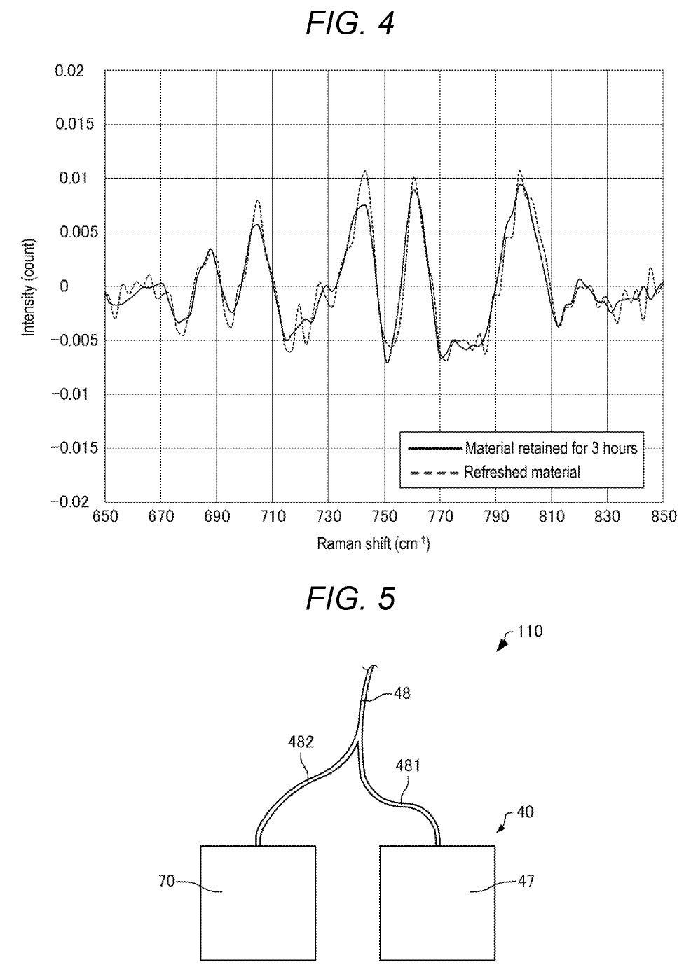

Here, FIG. 4 is a graph showing Raman spectra of a material retained in the flow path of the heating cylinder for 3 hours and of a refreshed material obtained by discharging the material in the flow path once and plasticizing the material again. FIG. 4 shows the results of the second derivative. The material retained for 3 hours is indicated by a solid line, and the refreshed material is indicated by a broken line. As a material, OKP was used. As shown in FIG. 4, the peak intensity of the material retained for 3 hours was lower than that of the refreshed material. It is considered that the peak intensity of the material retained for 3 hours decreased because the length of the molecular chain of the material changed by heat. From the above, it was found that the state of the material can be determined from the peak intensity of the Raman spectrum.

In step S2, the control unit 60 determines whether the intensity of a predetermined peak is smaller than a reference value, for example. The reference value is set in advance. For example, when OKP is used as the material, the reference value is set based on the Raman spectrum of the "refreshed material" in FIG. 4. For example, when the intensity of the predetermined peak is equal to or greater than the reference value, the control unit 60 determines that the state of the material is "OK", and when the intensity of the predetermined peak is smaller than the reference value, the control unit 60 determines that the state of the material is "NG (Not Good)". The control unit 60 causes a determination result of the state of the material to be displayed on the display unit 50.

When it is determined "NG (Not Good)" in step S2 ("NO" in step S2 in FIG. 3), the control unit 60 determines that the material is deteriorated, and in step S3, causes the injection unit 20 to purge the material retained in the flow path 23. Specifically, the control unit 60 drives the drive units 26 and 29 and a heating unit (not illustrated) to purge the material from the nozzle 24 to the outside. The purge of the material is performed so as not to enter the cavity 8.

In step S3, the purge of the material may be performed a plurality of times. For example, the reference value in step S2 may be provided in a stepwise manner, and the number of purges may be determined. For example, when the peak intensity is equal to or greater than the first reference value and equal to or less than the second reference value, the control unit 60 may cause the injection unit 20 to perform the purge once, and when the peak intensity is less than the first reference value, the control unit 60 may cause the injection unit 20 to perform the purge twice.

Next, in step S4, the control unit 60 controls the injection unit 20 and the mold clamping unit 30 to perform injection molding. When it is determined "NG (Not Good)" in step S2, injection molding is performed using the material newly supplied from the material supply unit 21 to the flow path 23.

In contrast, when it is determined "OK" in step S2 ("YES" in step S2 in FIG. 3), the control unit 60 omits the process of step S3 and proceeds to the process of step S4. When it is determined "OK" in step S2, injection molding is performed using the material retained in the flow path 23 without performing the purge.

Thereafter, the control unit 60 ends the processing.

Although the example in which the state of the material is determined based on the retention of the material has been described above, the flowability of the material may also be estimated from changes in peak intensity or peak shape relative to the immediately preceding actual values, for example, when there is a change in the manufacturing lot of the material. When the manufacturing lot is changed, the molecular weight of the material may be subtly different. When the molecular weight of the material is different, the peak intensity and the peak shape in the Raman spectrum change.

Although the example in which the state of the material is determined before injection molding is performed has been described above, the state of the material may be determined while performing injection molding. For example, the temperature of the plasticized material can be measured in real time from the peak intensity ratio between the Stokes light and the anti-Stokes light of the scattered light of the material.

For example, in the Raman spectrum obtained by the Raman spectrometer 46, the degree of polarization of the material to be measured and the degree of orientation of the fiber when the material includes the fiber can be obtained by the peak intensity. The composition of the material can be obtained by the wavenumber information. Further, strain, stress, and temperature of the material can be obtained by the peak shift. In addition, crystallinity and defects of the material can be obtained by the half width of the peak. When the material is made up of a plurality of substances, the relative proportion of each substance can be obtained by the peak ratio.

### 1.1.3. Action effects

The injection molding apparatus 100 includes the injection unit 20 that injects the material of the molded article into the mold 2, the mold clamping unit 30 to which the mold 2 is attached and clamps the mold 2, the optical measurement unit 40 that optically measures the material, and the control unit 60 that controls the injection unit 20, the mold clamping unit 30, and the optical measurement unit 40. The injection unit 20 includes the material supply unit 21 that supplies the material, the flow path 23 through which the supplied material flows, and the nozzle 24 that injects the material in the flow path 23. The optical measurement unit 40 includes the light guide unit 48 that guides light into the flow path 23, the irradiation unit 41 that irradiates the material with the light L via the light guide unit 48, and the Raman spectrometer 46 that receives the scattered light LL from the material via the light guide unit 48. The control unit 60 determines the state of the material based on the Raman spectrum obtained from the Raman spectrometer 46.

Therefore, in the injection molding apparatus 100, since it is not necessary to guide the gas generated from the material to the outside of the flow path 23 in order to determine the state of the material, it is possible to accurately determine the state of the material while reducing the possibility that the material leaks to the outside of the flow path 23. This makes it possible to accurately determine the influence on the quality of the molded article. Further, the weight of the molded article can be stabilized.

In the injection molding apparatus 100, the distance between the irradiation light emission surface 48a of the light guide unit 48 and the nozzle 24 is smaller than the distance between the irradiation light emission surface 48a and the material discharge port 21a of the material supply unit 21. Therefore, in the injection molding apparatus 100, the state of the material immediately before the injection into the mold 2 can be determined, and the influence on the quality based on the state of the material can be more accurately determined.

In the injection molding apparatus 100, the control unit 60 causes the injection unit 20 to purge the material when it is determined that the state of the material is deteriorated. Therefore, in the injection molding apparatus 100, it is possible to reduce the possibility of the occurrence of a defect in the molded article due to deteriorated material. Since the length of the molecular chain of the material deteriorated by heat changes, the molecular weight changes. When the molecular weight changes, the viscosity of the plasticized material changes, which alters its flowability, causing fluctuations in the quality of the molded article and resulting in a molded article defect. Such a problem can be avoided in the injection molding apparatus 100. Further, in the injection molding apparatus 100, it is possible to reduce the possibility that the material in which the state of the material is not deteriorated is purged, and it is possible to reduce the waste and improve the facility operation rate.

The injection molding apparatus 100 includes the display unit 50 on which a determination result of the state of the material is displayed. Therefore, the user of the injection molding apparatus 100 can confirm the state of the material.

### 1.2. Modifications of Injection Molding Apparatus

### 1.2.1. First Modification

Next, an injection molding apparatus according to a first modification of the first embodiment will be described with reference to the drawings. FIG. 5 is a diagram schematically illustrating the optical measurement unit 40 of an injection molding apparatus 110 according to the first modification of the first embodiment.

Hereinafter, in the injection molding apparatus 110 according to the first modification of the first embodiment, members having the same functions as those of constituent members of the injection molding apparatus 100 according to the first embodiment described above are denoted by the same reference numerals, and detailed description thereof will be omitted. This is the same in the injection molding apparatus according to the second modification of the first embodiment to be described later.

In the injection molding apparatus 110, as illustrated in FIG. 5, the optical measurement unit 40 differs from that of the above-described injection molding apparatus 100 in that it includes a near-infrared (NIR) module 70 that performs near-infrared spectroscopy (NIRS) on the material.

In the optical measurement unit 40 of the injection molding apparatus 110, the light guide unit 48 is bifurcated into a first branch portion 481 and a second branch portion 482. The first branch portion 481 is coupled to the housing 47 that houses the irradiation unit 41, the Raman spectrometer 46, and the like. The first branch portion 481 allows the light from the irradiation unit 41 to pass therethrough and allows the scattered light from the material due to light from the irradiation unit 41 to pass therethrough. The second branch portion 482 is coupled to an NIR module 70. The second branch portion 482 allows the light from the NIR module 70 to pass therethrough and allows the scattered light from the material due to light from the NIR module 70 to pass therethrough.

The NIR module 70 performs NIRS on the material in the flow path 23. The NIR module 70 includes a light source such as a halogen lamp and a spectroscope. The light source of the NIR module 70 and the irradiation unit 41 are not simultaneously driven. When light is emitted from the light source of the NIR module 70, light is not emitted from the irradiation unit 41. Conversely, when light is emitted from the irradiation unit 41, light is not emitted from the light source of the NIR module 70.

The NIR module 70 can detect the moisture content of the material in the flow path 23. The intensity of the reflected light spectrum at a wavelength of 1940 nm in NIRS varies depending on the moisture content of the material. Therefore, the moisture content of the material in the flow path 23 can be detected based on a calibration table created by measuring the reflected light spectrum of a sample whose moisture content is known in advance and the reflected light spectrum of the material in the flow path 23.

The control unit 60 determines the state of the material based on the moisture content of the detected material. For example, the control unit 60 determines "OK" when the moisture content of the material is less than the reference value, and determines "NG (Not Good)" when the moisture content of the material is greater than or equal to the reference value.

The injection molding apparatus 110 includes the NIR module 70 that performs NIRS on the material. Therefore, the injection molding apparatus 110 can detect the moisture content of the material.

### 1.2.2. Second Modification

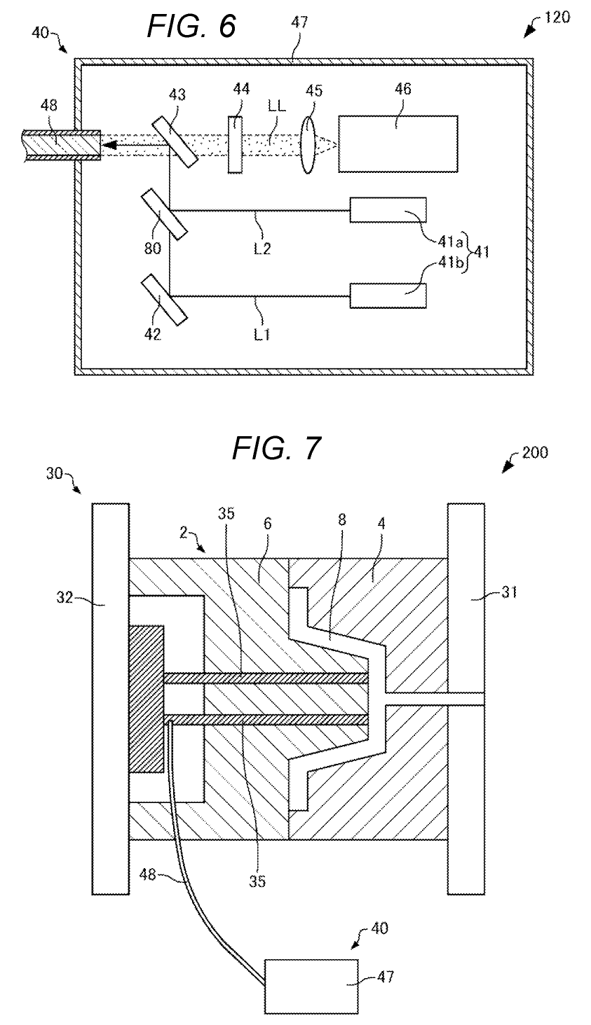

Next, an injection molding apparatus according to a second modification of the first embodiment will be described with reference to the drawings. FIG. 6 is a diagram schematically illustrating the optical measurement unit 40 of an injection molding apparatus 120 according to the second modification of the first embodiment.

As illustrated in FIG. 6, in the injection molding apparatus 120, the irradiation unit 41 differs from that of the above-described injection molding apparatus 100 in that it includes a plurality of light sources. In the illustrated example, the irradiation unit 41 includes a first laser light source 41a and a second laser light source 41b. Further, the optical measurement unit 40 includes a dichroic filter 80.

The wavelength of the light L1 emitted from the first laser light source 41a differs from the wavelength of the light L2 emitted from the second laser light source 41b, and vice versa. The wavelength of the light L1 is, for example, 532 nm. The wavelength of the light L2 is, for example, 785 nm. The second laser light source 41b is, for example, a laser light source having a narrow line width of 100 mW or less.

The first laser light source 41a and the second laser light source 41b are not simultaneously driven. When the light L1 is emitted from the first laser light source 41a, the light L2 is not emitted from the second laser light source 41b. Conversely, when the light L2 is emitted from the second laser light source 41b, the light L1 is not emitted from the first laser light source 41a. Thus, the wavelength of the light emitted from the irradiation unit 41 is variable.

The dichroic filter 80 is provided between the mirror 42 and the dichroic filter 43. The dichroic filter 80 transmits the light L1 emitted from the first laser light source 41a and reflects the light L2 emitted from the second laser light source 41b.

For example, when the material in the flow path 23 is irradiated with the light L1 by driving the first laser light source 41a, fluorescence may be generated from the material. In such a case, the driving of the first laser light source 41a is stopped, the second laser light source 41b is driven, and the material is irradiated with the light L2 from the second laser light source 41b. Accordingly, Raman spectroscopy can be performed on the material in the flow path 23 while suppressing fluorescence from the material. When fluorescence is generated from the material, the accuracy of Raman spectroscopy may decrease.

In the injection molding apparatus 120, the wavelength of the light emitted from the irradiation unit 41 is variable. Therefore, in the injection molding apparatus 120, Raman spectroscopy can be performed on the material while suppressing fluorescence from the material. Thereby, the degree of freedom of the material type can be enhanced.

### 2. Second Embodiment

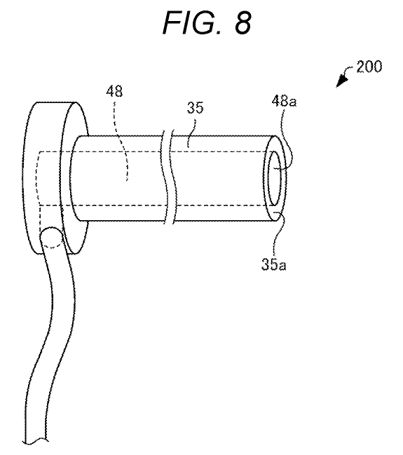

Next, an injection molding apparatus according to a second embodiment will be described with reference to the drawings. FIG. 7 is a diagram schematically illustrating an injection molding apparatus 200 according to the second embodiment. FIG. 8 is a diagram schematically illustrating an extrusion unit 35 and a light guide unit 48 of the injection molding apparatus 200 according to the second embodiment. For convenience, in FIG. 7, illustration of members other than a mold 2, a fixed mold attachment portion 31, a movable mold attachment portion 32, the extrusion unit 35, and an optical measurement unit 40 is omitted. In FIG. 7, the extrusion unit 35 and the light guide unit 48 are illustrated in a simplified manner.

Hereinafter, in the injection molding apparatus 200 according to the second embodiment, members having the same functions as those of constituent members of the injection molding apparatus 100 according to the first embodiment described above are denoted by the same reference numerals, and detailed description thereof will be omitted.

In the injection molding apparatus 100 described above, as illustrated in FIG. 1, the light guide unit 48 guides the light irradiated from the irradiation unit 41 into the flow path 23 of the injection unit 20.

In contrast, in the injection molding apparatus 200, as illustrated in FIGS. 7 and 8, the light guide unit 48 guides the light irradiated from the irradiation unit 41 into a cavity 8.

In the example illustrated in FIG. 8, the light guide unit 48 passes through the inside of the extrusion unit 35. An irradiation light emission surface 48a of the light guide unit 48 forms the inner surface of the cavity 8. The irradiation light emission surface 48a is, for example, flush with an end surface 35a of the extrusion unit 35. Accordingly, the molded article can be smoothly pushed out.

In the injection molding apparatus 200, Raman spectroscopy is performed on the material in the cavity 8. In the injection molding apparatus 200, Raman spectroscopy can be performed on the material from the plasticized state to the solidified state in the cavity 8. Accordingly, when fibers are contained in the material, the degree of orientation of the fibers contained in the material can be obtained by the polarization characteristic analysis of the vibration mode. Further, the stress of the molded article can be obtained by the polarization characteristic analysis of the vibration mode. Further, when the material has crystallinity, the degree of progress of crystallization during cooling and solidification of the material can be obtained.

In the injection molding apparatus 200, for example, a control unit 60 changes at least one control condition of the injection unit 20 and a mold clamping unit 30 based on a determination result of the state of the material in the cavity 8. For example, when it is determined that the degree of orientation of the fibers contained in the material is larger than the reference value, the control unit 60 controls the drive units 26 and 29 of the injection unit 20 to change the injection speed of the plasticized material. When it is determined that the stress of the molded article is greater than the reference value, the control unit 60 controls the drive unit 34 of the mold clamping unit 30 to decrease the mold clamping force. When it is determined that the degree of crystallization of the material is smaller than the reference value, the control unit 60 controls the drive unit 34 of the mold clamping unit 30 to increase the time from when the material is injected into the cavity 8 until the mold 2 is opened.

In the injection molding apparatus 200, the light guide unit 48 guides light into the cavity 8, and the control unit 60 determines the state of the material based on the Raman spectrum obtained from a Raman spectrometer 46. Therefore, in the injection molding apparatus 200, since it is not necessary to guide the gas generated from the material to the outside of the cavity 8 in order to determine the state of the material, it is possible to accurately determine the state of the material while reducing the possibility that the material leaks to the outside of the cavity 8.

In the injection molding apparatus 200, the light guide unit 48 passes through the inside of the extrusion unit 35. Therefore, in the injection molding apparatus 200, Raman spectroscopy can be performed on the material in the cavity 8 with a simple configuration.

In the injection molding apparatus 200, the control unit 60 changes at least one control condition of the injection unit 20 and the mold clamping unit 30 based on a determination result of the state of the material. Therefore, in the injection molding apparatus 200, injection molding can be performed under appropriate control conditions according to the state of the material.

Although not illustrated, the injection molding apparatus according to the present disclosure may include, as in the injection molding apparatus 100, the optical measurement unit 40 for performing Raman spectroscopy on the material in the flow path 23, and, as in the injection molding apparatus 200, the optical measurement unit 40 for performing Raman spectroscopy on the material in the cavity 8.

### 3. Third Embodiment

Next, an injection molding apparatus according to a third embodiment will be described. Hereinafter, in the injection molding apparatus according to the third embodiment, points different from the example of the injection molding apparatus 100 according to the embodiment described above will be described, and description of similar points will be omitted.

In the injection molding apparatus 100 described above, the material stored in a material supply unit 21 is polyester.

In contrast, in the injection molding apparatus according to the third embodiment, the material stored in the material supply unit 21 is a material other than polyester.

In the injection molding apparatus according to the third embodiment, the material stored in the material supply unit 21 may be a thermoplastic resin other than polyester. Examples of the thermoplastic resin include general-purpose plastic, general-purpose engineering plastic, and super engineering plastic.

Examples of the general-purpose plastic include acrylonitrile butadiene styrene (ABS) resin, polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), and polybutylene terephthalate (PBT).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyetheretherketone (PEEK).

The material stored in the material supply unit 21 is not limited to the thermoplastic resin, and may be a thermosetting resin. The material stored in the material supply unit 21 may include fibers, pigments, metals, ceramics, and the like.

The embodiments and the modifications described above are merely examples, and the present disclosure is not limited thereto. For example, each of the embodiments and each of the modifications can also be combined as appropriate.

The present disclosure includes substantially the same configurations as the configurations described in the embodiment, such as configurations having the same functions, methods, and results, or configurations having the same objects and advantages. Further, the present disclosure includes configurations obtained by replacing non-essential portions of the configurations described in the embodiment. Furthermore, the present disclosure includes configurations that achieve the same functions and advantages or configurations that can achieve the same objects as those of the configurations described in the embodiments. Further, the present disclosure includes a configuration obtained by adding a known technique to the configurations described in the embodiments.

The following contents are derived from the embodiments and modifications described above.

One aspect of an injection molding apparatus is an injection molding apparatus for performing injection molding of a molded article using a mold, the injection molding apparatus including:

an injection unit that injects a material of the molded article into the mold; a mold clamping unit to which the mold is attached and which clamps the mold; an optical measurement unit that optically measures the material; and a control unit that controls the injection unit, the mold clamping unit, and the optical measurement unit; in which

the injection unit includes a material supply unit that supplies the material, a flow path through which the supplied material flows, and a nozzle that injects the material in the flow path,

the optical measurement unit includes a light guide unit that guides light into the flow path, an irradiation unit that irradiates the material with light via the light guide unit, and a Raman spectrometer that receives scattered light from the material via the light guide unit, and

the control unit determines a state of the material based on a Raman spectrum obtained from the Raman spectrometer.

According to the injection molding apparatus, it is possible to accurately determine the state of the material while reducing the possibility of leakage of the material.

One aspect of an injection molding apparatus is an injection molding apparatus for performing injection molding of a molded article using a mold having a cavity, the injection molding apparatus including:

an injection unit that injects a material of the molded article into the cavity; a mold clamping unit to which the mold is attached and which clamps the mold; an optical measurement unit that optically measures the material; and a control unit that controls the injection unit, the mold clamping unit, and the optical measurement unit; in which

the optical measurement unit includes a light guide unit that guides light into the cavity, an irradiation unit that irradiates the material with light via the light guide unit, and a Raman spectrometer that receives scattered light from the material via the light guide unit, and

the control unit determines a state of the material based on a Raman spectrum obtained from the Raman spectrometer.

According to the injection molding apparatus, it is possible to accurately determine the state of the material while reducing the possibility of leakage of the material.

In one aspect of the injection molding apparatus, the optical measurement unit may include a near-infrared spectroscopy module for performing near-infrared spectroscopy on the material.

According to the injection molding apparatus, the moisture content of the material can be detected.

In one aspect of the injection molding apparatus, a wavelength of the light emitted from the irradiation unit may be variable.

According to the injection molding apparatus, Raman spectroscopy can be performed on the material while suppressing fluorescence from the material.

In one aspect of the injection molding apparatus, the distance between the irradiation light emission surface of the light guide unit and the nozzle may be smaller than the distance between the irradiation light emission surface and a material discharge port of the material supply unit.

According to the injection molding apparatus, the state of the material immediately before the injection into the mold can be determined, and the influence on the quality based on the state of the material can be more accurately determined.

In one aspect of the injection molding apparatus,

the mold may include a fixed mold and a movable mold,

wherein the mold clamping unit may include:

a fixed mold attachment portion to which the fixed mold is attached;

a movable mold attachment portion to which the movable mold is attached and which is movable with respect to the fixed mold attachment portion; and

an extrusion unit configured to extrude the molded article from the mold by the movement of the movable mold, and

the light guide unit may pass through the inside of the extrusion unit.

According to the injection molding apparatus, Raman spectroscopy can be performed on the material in the cavity with a simple configuration.

In one aspect of the injection molding apparatus, the control unit may change at least one control condition of the injection unit and the mold clamping unit based on a determination result of the state of the material.

According to the injection molding apparatus, injection molding can be performed under appropriate control conditions according to the state of the material.

In one aspect of the injection molding apparatus, the control unit may cause the injection unit to purge the material when it is determined that the state of the material is deteriorated.

According to the injection molding apparatus, it is possible to reduce the possibility of occurrence of a defect in the molded article due to deteriorated material.

In one aspect of the injection molding apparatus, a display unit on which a determination result of the state of the material is displayed may be provided.

According to the injection molding apparatus, the user can confirm the state of the material.

What is claimed is:

1. An injection molding apparatus for performing injection molding of a molded article using a mold, the injection molding apparatus comprising:
an injection unit configured to inject a material of the molded article into the mold;
a mold clamping unit to which the mold is attached and which clamps the mold;
an optical measurement unit configured to optically measure the material; and
a control unit configured to control the injection unit, the mold clamping unit, and the optical measurement unit; wherein
the injection unit comprises a material supply unit configured to supply the material, a flow path through which the supplied material flows, and a nozzle configured to inject the material into the flow path,
the optical measurement unit comprises a light guide unit configured to guide light into the flow path, an irradiation unit configured to irradiate the material with light via the light guide unit, and a Raman spectrometer configured to receive scattered light from the material via the light guide unit, and
the control unit is configured to determine a state of the material based on a Raman spectrum obtained from the Raman spectrometer.

2. The injection molding apparatus according to claim 1, wherein the optical measurement unit comprises a near-infrared spectroscopy module for performing near-infrared spectroscopy on the material.

3. The injection molding apparatus according to claim 1, wherein a wavelength of the light emitted from the irradiation unit is variable.

4. The injection molding apparatus according to claim 1, wherein a distance between an irradiation light emission surface of the light guide unit and the nozzle is smaller than a distance between the irradiation light emission surface and a material discharge port of the material supply unit.

5. The injection molding apparatus according to claim 1, wherein the control unit changes at least one control condition of the injection unit and the mold clamping unit based on a determination result of the state of the material.

6. The injection molding apparatus according to claim 1, wherein the control unit causes the injection unit to purge the material when it is determined that the state of the material is deteriorated.

7. The injection molding apparatus according to claim 1, comprising a display unit on which a determination result of the state of the material is displayed.

8. An injection molding apparatus for performing injection molding of a molded article using a mold having a cavity, the injection molding apparatus comprising:
an injection unit that injects a material of the molded article into the cavity; a mold clamping unit to which the mold is attached and which clamps the mold; an optical measurement unit that optically measures the material; and a control unit that controls the injection unit, the mold clamping unit, and the optical measurement unit; wherein
the optical measurement unit comprises a light guide unit that guides light into the cavity, an irradiation unit that irradiates the material with light via the light guide unit, and a Raman spectrometer that receives scattered light from the material via the light guide unit, and
the control unit determines a state of the material based on a Raman spectrum obtained from the Raman spectrometer.

9. The injection molding apparatus according to claim 8, wherein
the mold comprises a fixed mold and a movable mold,
the mold clamping unit comprises:
a fixed mold attachment portion to which the fixed mold is attached;
a movable mold attachment portion to which the movable mold is attached and which is movable with respect to the fixed mold attachment portion; and
an extrusion unit configured to extrude the molded article from the mold by the movement of the movable mold, and
the light guide unit passes through the inside of the extrusion unit.
